(19) United States
(12) Patent Application Publication
(10) Pub. No.: US 2009/0183474 A1
(43) Pub. Date: Jul. 23, 2009

(54) AIR FILTER

(76) Inventor: Roger L. Workman, Jeffersonville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/018,634

(22) Filed: Jan. 23, 2008

(51) Int. Cl. B01D 50/00

(52) U.S. Cl. 55/385.2

(57) ABSTRACT

An HVAC air filter having a frame is disclosed. The frame disclosed includes filtration media and corners designed to allow for the expansion of the frame. The expansion of the frame allows for full nesting of multiple air filters.

The present invention relates generally to air filters and, more particularly, to air filters usable in HVAC systems.

### BACKGROUND

Air filters are typically provided in heating, ventilating and/or air conditioning (HVAC) equipment. Various types and designs of such air filters are known in the art. One such example is set forth in U.S. Pat. No. 4,636,233 showing a filter assembly with a casing having a support panel and walls extending around the periphery. There is a need for an improved air filter that optionally provides nesting with other air filters during packing, storage and/or transportation.

### SUMMARY

The present invention provides an improved HVAC air filter. The claims, and only the claims, define the invention.

The present invention may include a rectilinear frame with four corners and filtration media positioned within the frame. The frame of the present invention may also allow for the expansion of the frame at the corners. The frame may be suitable for nesting with other like filters.

One object of the present invention is to provide an improved nestable HVAC air filter.

### BRIEF DESCRIPTION OF THE DRAWINGS

FIG. 1 is a top view showing one example of a top portion of an air filter.

FIG. 2 is a top view showing one example of a bottom portion of an air filter.

FIG. 3 is a perspective view showing one example of an air filter.

FIG. 4 is a perspective view showing one example of a corner of an filter.

FIG. 5 is a cross-sectional view of one example of an air filter.

FIG. 6A is a enlarged view of the end of one end of the air filter.

FIG. 6B is an alternative example showing pleated filtration media.

FIG. 7 is a cross section of a plurality of nested air filters.

FIG. 8 is an enlarged perspective of another embodiment of a corner of an air filter.

FIG. 9 is a top view showing another example of a top portion of an air filter.

FIG. 10 is a top view showing another example of a bottom portion of an air filter.

FIG. 11 is a perspective view of one corner of one example of an air filter.

FIG. 12 is a top view showing one example of a top portion of an air filter.

FIG. 13 is a top view showing one example of a bottom portion of an air filter.

FIG. 14 is a perspective view of one corner of an air filter.

FIG. 15 is a cross sectional view of an air filter taken across line A-A of FIG. 9.

FIG. 16 is a top view of yet another example of a top portion of a filter.

FIG. 17 is a top view showing one example of yet another bottom portion of an air filter.

FIG. 18 is a cross sectional view of an air filter taken along line B-B of FIG. 17.

### BRIEF DESCRIPTION OF THE PREFERRED EMBODIMENT

For the purposes of promoting an understanding of the principles, reference will now be made to the embodiments illustrated herein and specific language will be used to describe the same. It will nevertheless be understood that no limitation of the scope of the invention is thereby intended. Any alterations and further modifications in the described processes, systems or devices, any further applications of the principles of the invention as described herein, are contemplated as would normally occur to one skilled in the art to which the invention relates, now and/or in the future.

As used in the claims and the specification, the following terms have the following definitions:

The term “HVAC”, while short for heating, ventilating, and air conditioning, includes any combination of the preceding functions, as well as any other systems or equipment incorporating air filtration means.

The terms “generally planar” and “planer” both mean that overall, the filter is taller and wider (X and Y) than it is thick (Z) and is flat enough to fit into the receptacle or slot in the HVAC system, but does not have to be absolutely flat or planar.

The term “filtration media” means any material, natural or synthetic, designed to remove particles or impurities when air travels through. The shape or design of the filtration media is not limited to any particular geometry. The materials may be any material, and polyester and/or polypropylene are but two examples.

The term “frame” is any structure that surrounds, either partially or completely, filtration media at or near its perimeter. It can be formed of paperboard, cardboard, plastic and/or metal or any other material suitable for use with HVAC systems.

The term “notch” means any cut angled, square, straight, curved or otherwise, or indentation, or recess in an object, surface or edge.

The term “grid” means any structure that supports the filtration media which has apertures to allow air to flow through the filtration media. The apertures are not limited to any particular geometry, and may be triangular, square, diamond-shaped, circular or otherwise. The grid may be made of paperboard, cardboard, plastic, metal, and/or wire or any other material suitable for use with HVAC systems. The grid may be internal with the frame or separate part(s) from the frame.

The language used in the claims is to only have its plain and ordinary meaning, except as explicitly defined above. Such plain and ordinary meaning is inclusive of all consistent dictionary definitions from the most recently published Webster's dictionaries and Random House dictionaries.

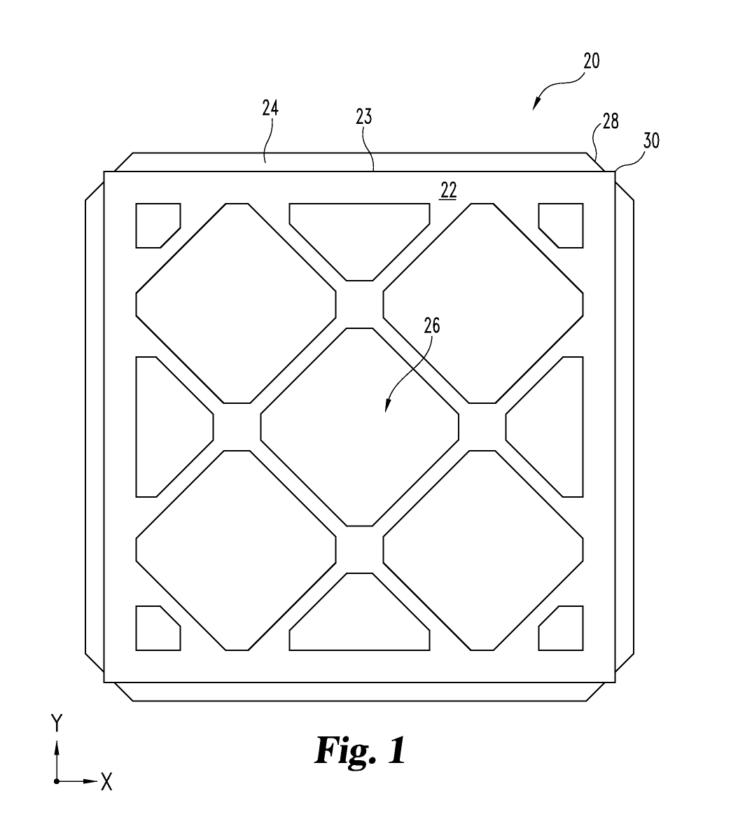

Referring generally to FIGS. 1-7, an air filter 19 optionally includes a top portion 20 and bottom portion 40. Referring specifically to FIG. 1, the top portion 20 optionally includes a grid 22 having corners 30. Optionally, four fold segments 24 may be connected around the periphery of grid 22 along fold lines 23. Holes 26 may be cut or stamped from grid 22. Holes 26 may be designed to minimize the surface area of grid 22 while maintaining adequate structural integrity. Angular ends 28 are optionally located at each end of fold segments 24. As shown, the edge of angle ends 28 may terminate on fold line 23 at a distance from corner 30.

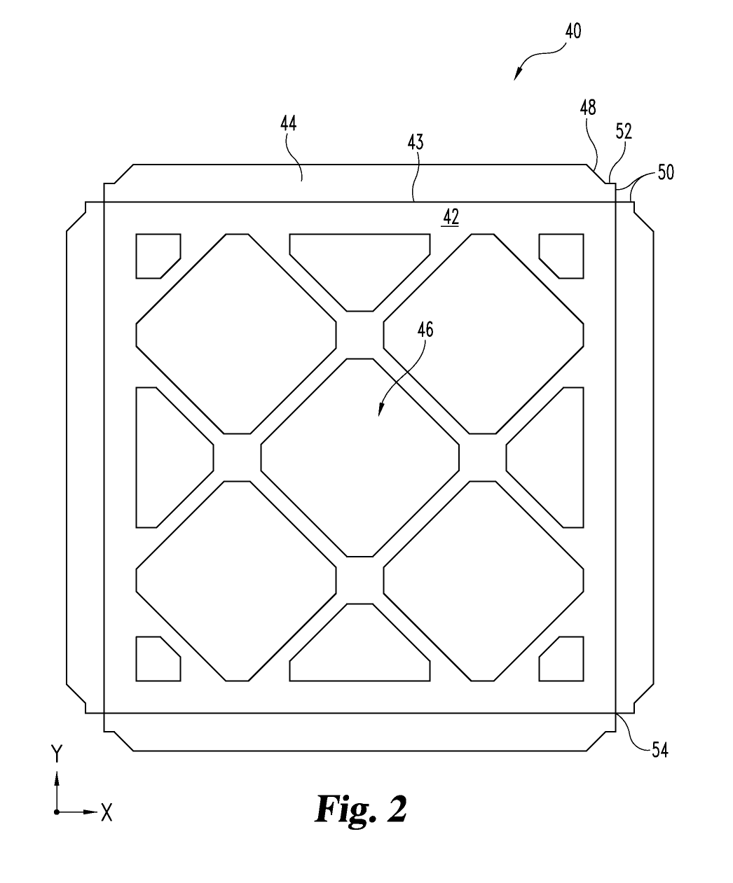

Referring now to FIG. 2, the bottom portion 40 optionally may include a grid 42. Like grid 22, grid 42 optionally has fold segments 44 connected around its periphery along fold lines 43. Holes 46 may be cut or stamped from grid 42. Optionally, angled sealing edge 50, and sealing edge 52, and angled ends 48 may be located at each end of fold segment 44. Optionally, sealing edge 52 runs substantially parallel to fold line 43 and angled sealing edge 50 extends from corner 54. The angle created by fold line 43 and angled ceiling edge 50 is optionally greater than 90 degrees.

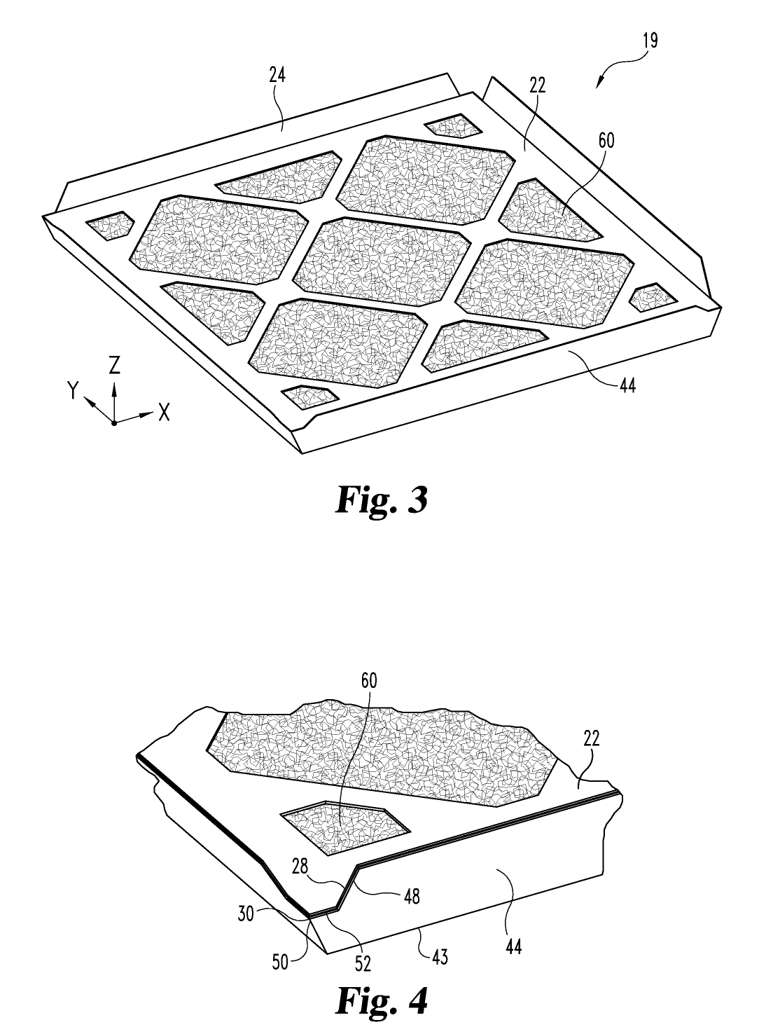

FIG. 3 depicts one example of an assembled air filter 19. As shown, grid 22 optionally maintains the placement of filtration media 60. Optionally, top portion 20 nests within and is affixed to bottom portion 40. As shown, fold segments 24 and 44 may be engaged and properly aligned. The resulting air filter 19 may preferably be rigid and fully nestable. Optionally, to fabricate a filter from top portion 20 and bottom portion 40, adhesive may be applied to bottom portion 40. Filtration media 60 may be placed over grid 42. Adhesive may then applied to one side of top portion 20. With grid 22 being properly aligned with filtration media 60, top portion 20 may be pressed down onto filtration media 60. Fold segments 24 may be folded up about fold line 23 and fold segments 44 may be folded up about fold line 43. A proper fit results when the upper edges of fold segments 24 and 44 are aligned. Optionally, it may not be necessary to apply adhesive to grids 22 and 42. Optionally, the top portion 20 and bottom portion 40 may be held together through adhesion of fold segments 24 and 44. Other means may be incorporated to adhere top portion 20, bottom portion 40 and/or filtration media 60, such as, but not limited to, gluing, stapling or capping.

Filtration media 60 (FIG. 6A) is merely one example of the type of filtration media. Such particular example is generally uniform strands or otherwise. Alternatively, other such filtration media may be used, alone or in combination. As but one example, FIG. 6B shows filtration media 60B which is a pleated media and a general wave form having a wave length of W and an amplitude of approximately A. Other pleated material, such as those having zig-zag folds or creases may be used. Note that, for example, the examples shown in FIG. 6A and FIG. 6B have such amplitude less, and preferably substantially less, than the overall thickness T_{A} of the filter and the filter frame. This allows for fitting into an HVAC filter receptacle corresponding to a thickness T_{A} even with filtration media having a lesser thickness. Optionally, filtration media thickness can be greater, lesser and/or non-uniform.

Note also that although the pleated example of FIG. 6B is limited to that figure, this may be used in all the other examples as well, but is not duplicated again in the drawings for the sake of brevity. Also, optionally such pleated media may be made with a grid interval therewith, such as a metal, wire or other grid in addition to and/or instead of grids such as grid 42 and/or grid 22.

A potential problem with some nestable air filter designs is that it may be difficult to always nest the filters together. Proper orientation of the filter on top of one another may be difficult to obtain.

Optionally, notches may be provided at some or each corner of air filter 19. By providing these notches, it may become both easier and safer to stack a plurality air filters. FIG. 4 shows a detailed view of one of the corners of air filter 19. As shown, the incorporation of angled ends 28 and 48 may create a recess at each corner of air filter 19 above grid 22. This recess or notch may allow for easy nesting of air filters 19. During manufacture, angled sealing edges 50 of adjacent foldable portions 44 may be brought in close proximity, creating a seal. As is explained in greater detail below, it is optional that angled sealing edges 50 are cut at the appropriate angle to ensure a proper fit. This is because foldable portions 44 may not extend from grid 42 at a right angle. Further, corner 30 of grid 22 optionally sits against the vertex created by adjacent sealing edges 52. From this design a proper seal may be formed at each corner of air filter 19, thereby reducing the amount of air capable of circumventing a passage through filtration media 60.

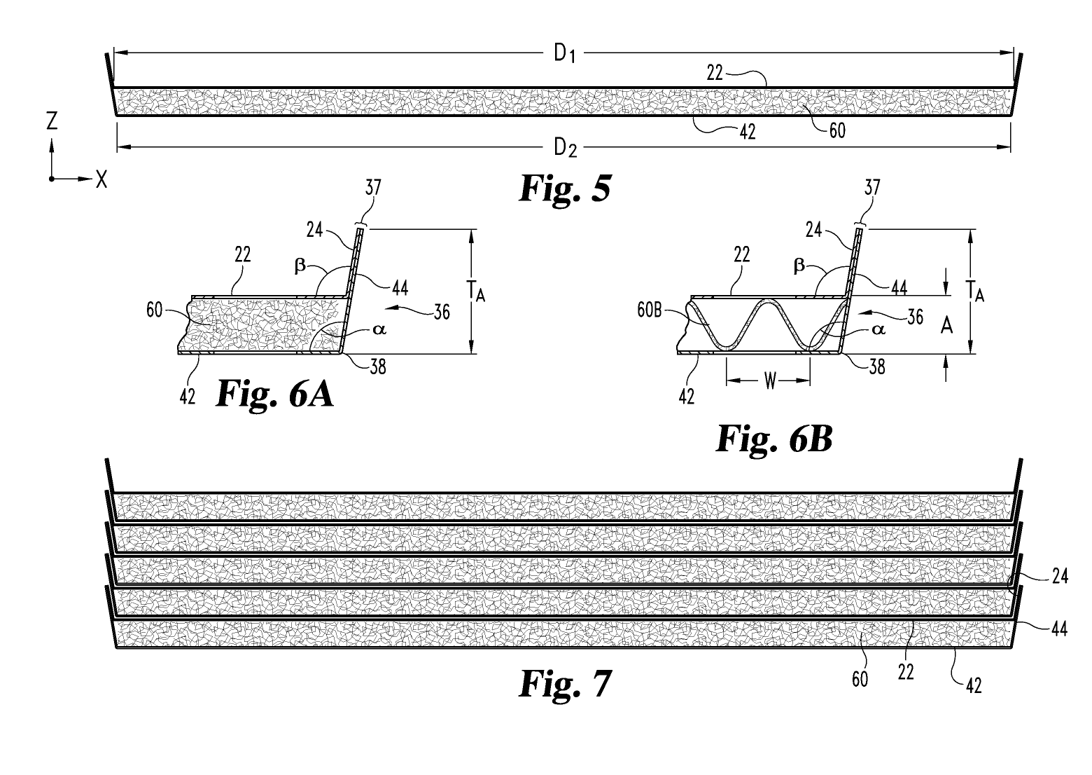

As was previously mentioned, it may be desired that a plurality of air filters 19 nest into one filter and be able to receive another. This configuration may be obtained through proper design of top portion 20 and bottom portion 40. As shown in FIG. 5, grid 22 optionally has a dimension D1 and grid 42 has a dimension D2. As shown by the X-Y axis in FIGS. 1 and 2, grids 22 and 42 may sit in the X-Y plane while the thickness T_{A} (see for examples FIGS. 6A and 6B) of air filter 19 runs substantially along the Z axis. Thus grids 22 and 42 may lie in parallel X-Y planes. Referring again to dimensions D1 and D2, they may optionally correspond to either the length or width of grids 22 and 42, respectively. Optionally, D1 may be larger than D2.

As illustrated more clearly in FIG. 6, a larger dimension of D1 may optionally force grid 22 to press against and outwardly dispose fold segments 44. In this arrangement, an obtuse angle α is created between grid 42 and fold segment 44. Similarly, an obtuse angle β is created between grid 22 and fold segment 24. Obtuse angles α and β may result in wall 36 being flared with respect to grids 22 and 42. As but one non-limiting example, if D1 is 11.5 inches and D2 is 11.44 inches, then angles α and β are about 10.5 degrees.

Wall 36 optionally includes an upper edge 37 and lower edge 38. Optionally, walls 36, upper edges 37 and/or lower edges 38 may define at least part of a rectilinear frame traversing the perimeter of air filter 19. This frame has a length, width and thickness. The thickness may be in the Z-axis direction. As shown, grid 22 optionally lies between upper edge 37 and lower edge 38. Upper edges 37 and lower edges 38 may define separate and distinct Z-plane, each of which being parallel to the X-Y plane. As shown, the Z-plane defined by grid 22 may lie between the Z-planes defined by upper edges 37 and lower edges 38.

Referring now to FIG. 7, a plurality of nested and stacked air filters 19 is shown. As illustrated, the area above grid 22 and fold segments 24 may receive grid 42 and fold segments 44 of a separate filter.

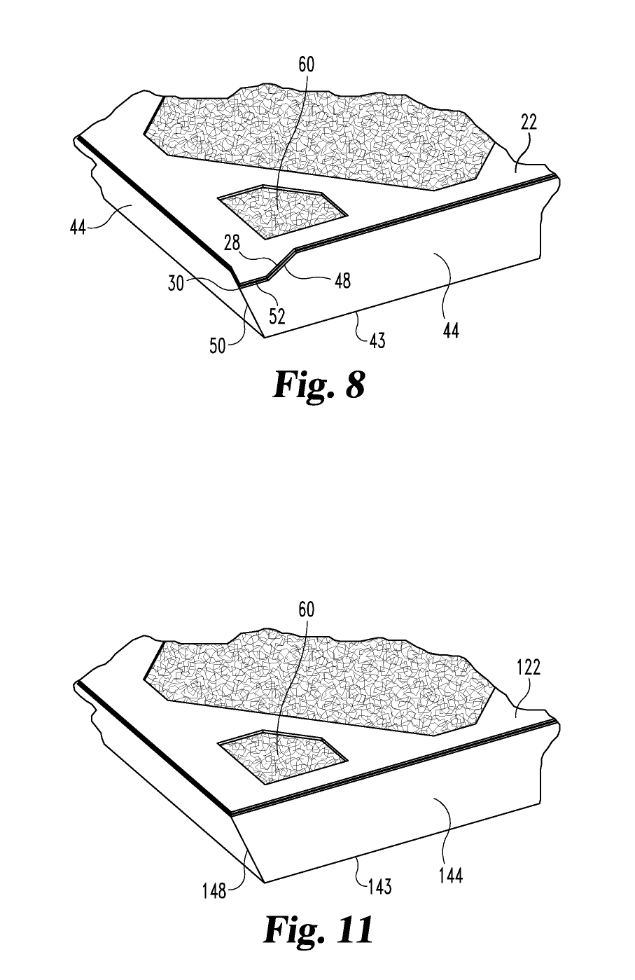

While FIG. 4 illustrates one example, and only one example, of a corner design for air filter 19, FIG. 8 illustrates yet another embodiment. Optionally, only one pair of opposing fold segments 44 connected to grid 42 include angled end 48 and sealing edge 52. Corresponding fold segments 24 have a similar design. Optionally, the opposite pair of opposing fold segments 24 and 44 may not include such angled ends and edges. Therefore, only a single notch may be created at each corner of an air filter.

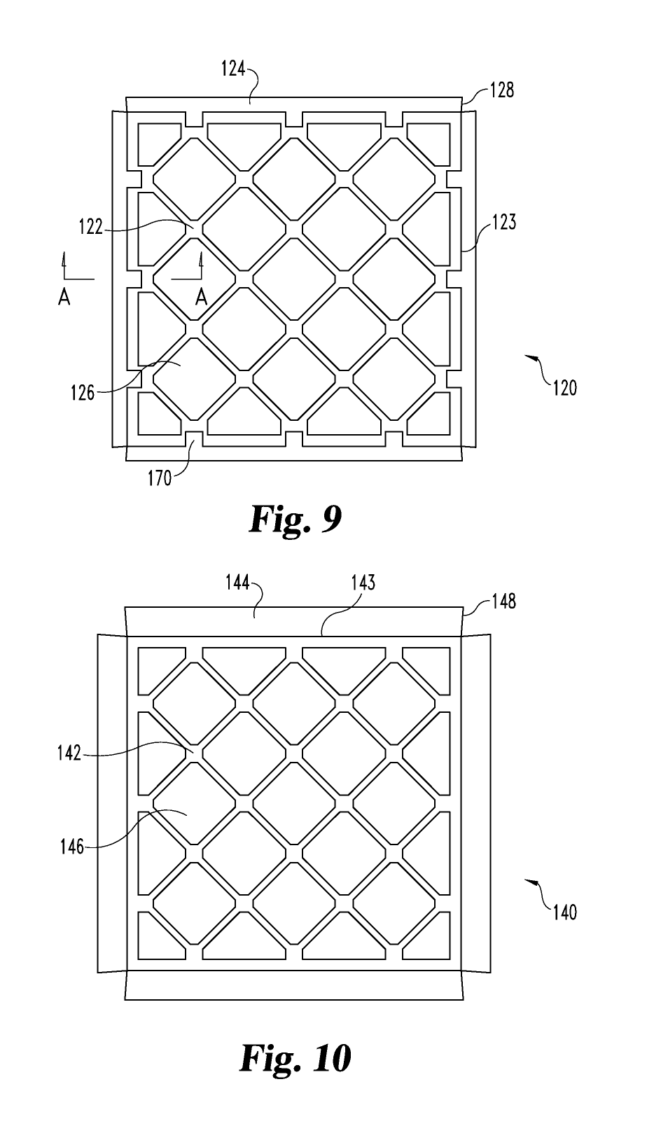

FIGS. 9 and 10 illustrate yet another optional example of a design for top portion 120 and bottom portion 140. Referring to top portion 120, similar to top portion 20, it optionally contains a grid 122 and fold segments 124, which are connected around the periphery of grid 122 along fold line 123. Each fold segment 124 optionally may have angular ends 128. Top portion 120 optionally further may include support tabs 170, which will be discussed in greater detail below. Now referring to FIG. 10, bottom portion 140 may include grid 142. Bottom portion 140 may also include fold segments 144 connected to grid 142 along fold lines 143. Each fold segment 144 optionally has angular ends 148.

As shown in FIG. 11, the angular ends 148 of adjacent fold segments 144 are brought in close proximity when the filter is constructed. Filtration media 60 is optionally located beneath grid 122 and above grid 142. It is optional that adjacent angular ends 148 are not adhered together, thereby allowing for the expansion of the frame of air filter when a plurality of filters is nested together.

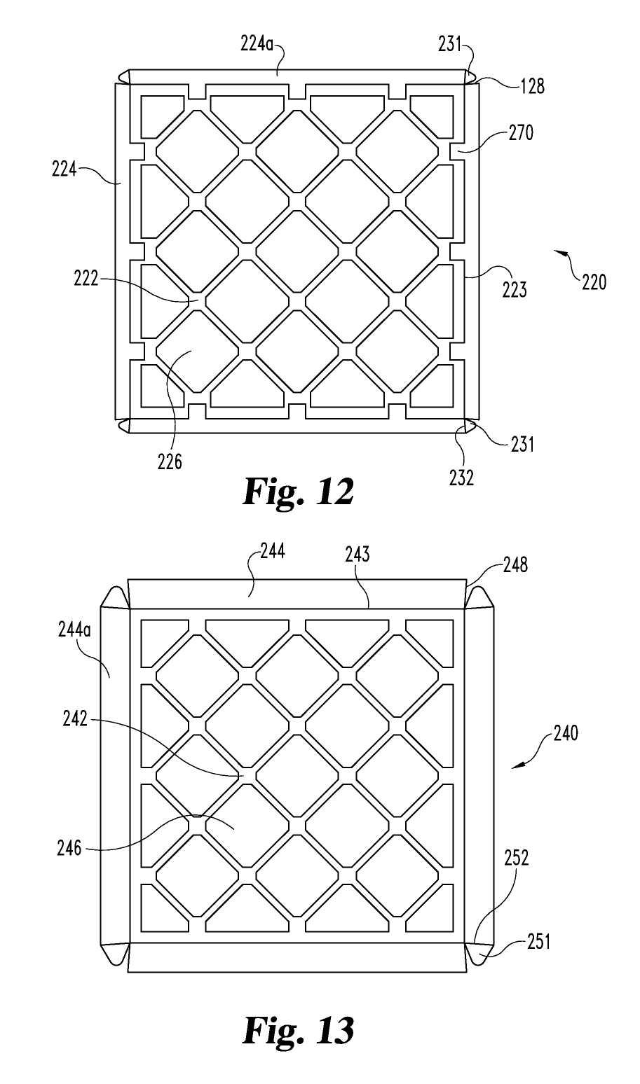

FIGS. 12 and 13 show yet another example of a possible top and bottom portion 220 and 240. Top portion 220 optionally includes grid 222 and fold segments 224 and 224a. Fold segments 224 and 224a are optionally connected to grid 222 along fold lines 223. As shown, a first pair of opposed fold segments 224 have angular ends 128, while a second pair of fold segments 224a have foldable tabs 231 located on their ends. Foldable tab 231 is connected to fold segment 224a at fold line 232. Top portion 220 further includes support tabs 270.

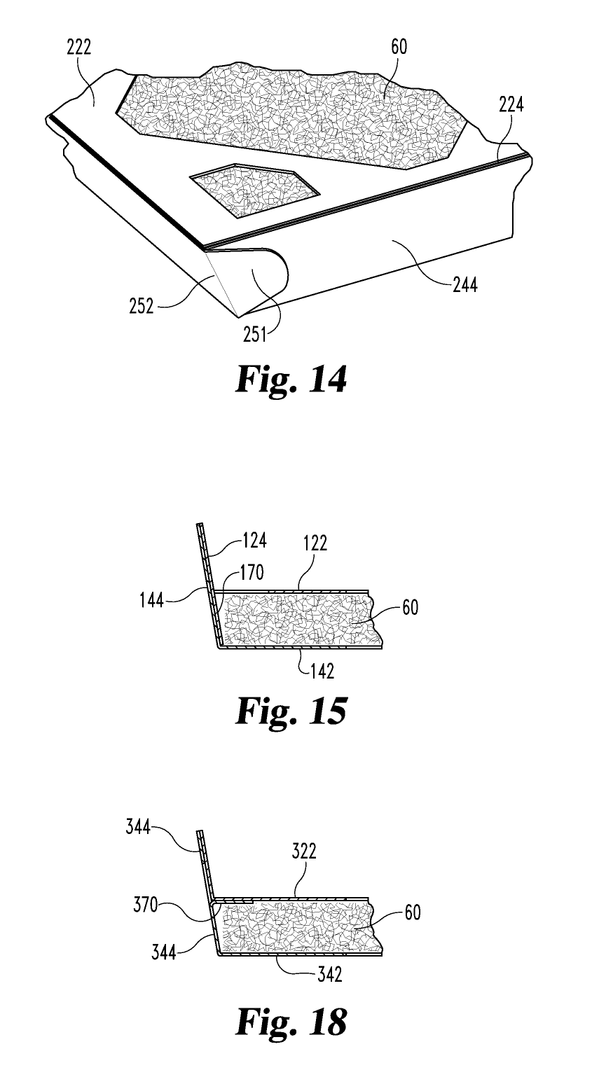

Now referring to FIG. 13, bottom portion 240 optionally includes grid 242, as well as fold segments 244 and 244a. Fold segments 244 and 244a are optionally connected to grid 242 along fold lines 243. Like top portion 220, a first pair of opposing fold segments 244 may include angular ends 248 while a second pair of opposing fold segments 244a have foldable tabs 251 at their ends. Foldable tab 251 is connected to fold segment 244a at fold line 252. As shown in FIG. 14, a manufactured air filter constructed from top portion 220 and bottom portion 240 has foldable tab 251 adhered to the adjacent fold segment 244.

As was previously noted, top portions 120 and 220 include support tabs 170 and 270, respectively. FIG. 15 illustrates an enlarged cross section of a constructed air filter taken along line A-A in FIG. 9. As shown, support 170 is optionally cut from top portion 120 to allow it to be partially detached from grid portion 122. This allows support tab 170 to extend down, optionally press against grid 142, and run adjacent to fold segment 144, which would increase the overall rigidity of the air filter. Optionally, the bottom edge of support tab 170 may rest against grid 142, thereby maintaining the spacing between grids 122 and 142. Optionally, this may ensure the top edges of fold segments 124 and 144 are even or flush. Support tabs similar to the support tabs 170 shown may be incorporated into any embodiment presented in this application and are not limited to any particular geometry.

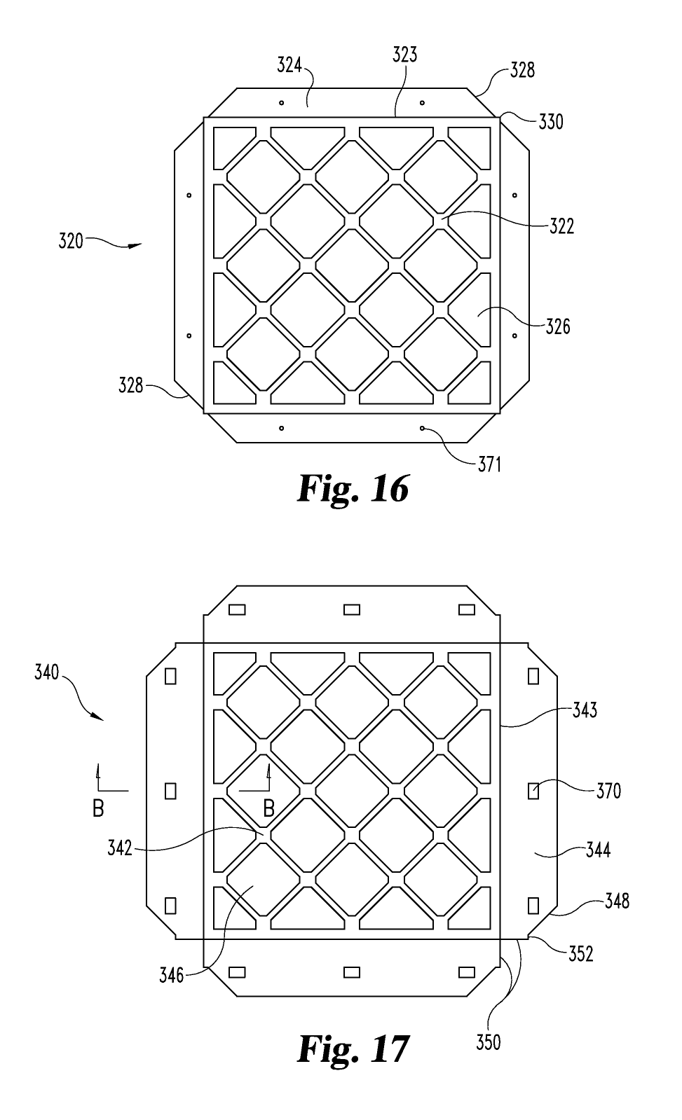

FIGS. 16 and 17 illustrate yet a further example of top portions 320 and bottom portion 340. Similar to top portion 20, top portion 320 optionally includes grid 332, fold lines 323, fold segments 323 and corners 330. Fold segments 324 optionally have angled ends 328 at each end. Holes 326 are cut or stamped to create grid 322. Further, fold segments 324 may optionally include holes 371. Bottom portion 340 may be substantially similar to bottom portion 20 in design. Bottom portion 340 optionally includes grid 342, fold lines 343 and fold segments 344. Each end of fold segment 344 optionally includes angled ends 348, angled sealing edges 350 and sealing edges 352. Further, fold segments 344 of bottom portion 340 optionally include support tabs 370. Optionally, the placement of support tabs 370 help to dictate the depth of the placement of top portion 320 about the Z axis. This is made further clear in FIG. 18.

FIG. 18 illustrates that support tab 370 is optionally cut away and folded down from fold segment 344 when the air filter is manufactured. Therefore, support tab 370 optionally comes in contact with and supports grid 322. Again, it is the opposing force provided from support tab 370 that may optionally restrict grid 322 from extending too far down with respect to fold segments 344. Support tabs similar to the support tabs 370 shown may be incorporated into any example presented in this application and are not limited to any particular geometry.

Optionally, holes 371 in fold segments 324 facilitate in the manufacture of the air filter. Optionally, top portion 320 may nest within and be affixed to bottom portion 340. Holes 371 optionally provide a location at which suction means can be employed to draw together fold segments 324 and 344. Such suction means allow for speedier construction of air filters. While holes 371 are shown having a circular shape, holes 371 are not limited to any particular geometry and may be, but not limited to, square, oval, triangular or rectangular. Such optional holes may be included in any of the examples to facilitate manufacturing.

An air filter may be comprised of a single grid and a single panel of filtration media, multiple grids and a single panel of filtration media, or multiple grids and multiple panels of filtration media. For brevity, the examples of air filters presented were shown in the drawings having multiple grids and a single panel of filtration media, but this is in no way limiting.

The present invention contemplates modifications as would occur to those skilled in the art. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

We claim:

1. An HVAC filter which is generally planar along an X-Y plane, the filter comprising:
a rectilinear frame around a perimeter of the filter, said frame having four corners, said frame having a thickness in a Z-axis direction being normal to the X-Y plane;
filtration media within said frame; and,
means for allowing for the expansion of said frame at said corners.

2. The filter of claim 1, wherein said means for allowing for the expansion of said frame includes four notches in a respective one of said four corners, said notches extending in the Z-axis direction at least partially along the thickness.

3. The filter of claim 1, wherein said frame has four peripheral walls, said peripheral walls being flared with respect to said filtration media to provide nestable stacking of like filters.

4. The filter of claim 1, wherein said rectilinear frame comprises a top portion and a bottom portion, said top portion nested within and affixed to said bottom portion.

5. The filter of claim 1, wherein said rectilinear frame has at least one grid retaining said filtration media within said rectilinear frame.

6. The filter of claim 4, wherein said top portion includes a first portion that lies in a plane parallel to the X-Y plane and includes a first pair of folds at opposed folded segments, a first X-dimension defined as the distance between said first folds;
said bottom portion includes a second portion that lies in a plane parallel to the X-Y plane and includes a second pair of folds at opposed folded segments, a second X-dimension defined as the distance between said second folds;
wherein said first X-dimension is greater than said second X-dimension.

7. The filter of claim 4, wherein said top portion has a top grid and said bottom portion had a bottom grid, said filtration media positioned between said top grid and said bottom grid.

8. The filter of claim 5, wherein said frame has four peripheral walls each having a top edge and a bottom edge, said top edge being displaced from said bottom edge along the Z-axis, one of said at least one grid located between said top edge and said bottom edge.

9. The filter of claim 5, wherein said at least one grid is formed by a single piece of material, said material having at least one opening stamped therein to form said grid.

10. The filter of claim 6 wherein said frame has four peripheral walls, said peripheral walls being flared with respect to said filtration media to provide nestable stacking of like filters.

11. The filter of claim 10, wherein said rectilinear frame comprises a top portion and a bottom portion, said top portion nested within and affixed to said bottom portion, said top portion having at least some walls flat against and inside of said peripheral walls of said frame, and a plurality of holes located in at least some of said walls to allow suction to pull adjacent walls together during manufacture of the filter.

12. The filter of claim 11, wherein said rectilinear frame has at least one grid retaining said filtration media within said rectilinear frame.

13. The filter of claim 12, wherein said top portion includes a first portion that lies in a plane parallel to the X-Y plane and includes a first pair of folds at opposed folded segments, a first X-dimension defined as the distance between said first folds;
said bottom portion includes a second portion that lies in a plane parallel to the X-Y plane and includes a second pair of folds at opposed folded segments, a second X-dimension defined as the distance between said second folds;
wherein said first X-dimension is greater than said second X-dimension.

14. The filter of claim 13, wherein said top portion has a top grid and said bottom portion had a bottom grid, said filtration media positioned between said top grid and said bottom grid.

15. The filter of claim 14, wherein said frame has four peripheral walls each having a top edge and a bottom edge, said top edge being displaced from said bottom edge along the Z-axis, one of said at least one grid located between said top edge and said bottom edge.

16. An HVAC filter which is generally planar in an X-Y plane, the filter comprising:
a rectilinear frame around a perimeter of the filter, said frame having a thickness in a Z-axis direction being normal to the X-Y plane, said frame having four peripheral walls each having a top edge and a bottom edge, said top edge being displaced from said bottom edge along the Z-axis;
filtration media mounted within said frame; and,
at least one grid within and connected to said frame, wherein said grid is parallel to said X-Y plane and is located along said thickness between said top edge and said bottom edge.

17. The filter of claim 16, wherein said frame has four peripheral walls, said peripheral walls being flared with respect to said filtration media to provide nestable stacking of like filters.

18. The filter of claim 16, wherein said rectilinear frame comprises a top portion and a bottom portion, said top portion nested within and affixed to said bottom portion.

19. The filter of claim 16, wherein said rectilinear frame has at least one grid retaining said filtration media within said rectilinear frame.

20. The filter of claim 16, wherein said top portion includes a first portion that lies in a plane parallel to the X-Y plane and includes a first pair of folds at opposed folded segments, a first X-dimension defined as the distance between said first folds;
said bottom portion includes a second portion that lies in a plane parallel to the X-Y plane and includes a second pair of folds at opposed folded segments, a second X-dimension defined as the distance between said second folds;
wherein said first X-dimension is greater than said second X-dimension.

21. The filter of claim 16, wherein said top portion has a top grid and said bottom portion had a bottom grid, said filtration media positioned between said top grid and said bottom grid.

22. An HVAC filter which is generally planar along an X-Y plane, the filter comprising:
a rectilinear frame around a perimeter of the filter, said frame having a thickness in a Z-axis direction being normal to the X-Y plane;
filtration media within said frame; and,
wherein said rectilinear frame comprises a top portion and a bottom portion, said top portion nested within and affixed to said bottom portion;
wherein said top portion includes a first portion that lies in a plane parallel to the X-Y plane and includes a first pair of folds at opposed folded segments, a first X-dimension defined as the distance between said first folds;
said bottom portion includes a second portion that lies in a plane parallel to the X-Y plane and includes a second pair of folds at opposed folded segments, a second X-dimension defined as the distance between said second folds;
wherein said frame has peripheral walls, said peripheral walls partially defined by said second folds, said peripheral walls being flared with respect to said filtration media to provide nestable stacking of like filters.

23. The filter of claim 22, wherein said top portion has a top grid and said bottom portion had a bottom grid, said filtration media positioned between said top grid and said bottom grid.

24. The filter of claim 23, wherein said peripheral walls each having a top edge and a bottom edge, said top edge being displaced from said bottom edge along the Z-axis, one of said at least one grid located between said top edge and said bottom edge.

25. The filter of claim 22, wherein said peripheral walls each having a top edge and a bottom edge, said top edge being displaced from said bottom edge along the Z-axis, one of said at least one grid located between said top edge and said bottom edge.

26. The filter of claim 22, and further comprising a plurality of holes located in at least some of said walls to allow suction to pull adjacent walls together during manufacture of the filter.
